(19) United States
(12) Patent Application Publication
(10) Pub. No.: US 2006/0064472 A1
(43) Pub. Date: Mar. 23, 2006

(54) Obtaining information for proximate devices

(76) Inventor: Charles A. Mirho, Vancouver, WA (US)

Correspondence Address: FSP LLC, P.O. BOX 890, VANCOUVER, WA, 98666, US

(21) Appl. No.: 10/945,818

(22) Filed: Sep. 20, 2004

(51) Int. Cl. G06F 15/177

(52) U.S. Cl. 709/220

(57) ABSTRACT

User-interface information is wirelessly communicated from a first device to a second device as a result of the second device being brought into proximity with the first device. The second device in configured in conformance with the user-interface information such that the second device provides a user-interface to the first device.

### TECHNICAL FIELD

The present disclosure relates to interfacing one device from another.

### BACKGROUND

As devices proliferate in the world, it becomes increasingly complex to learn different interfaces to operate the devices. Each device may come with its own buttons, levers, and other controls, and user/repair/maintenance instructions for the device. Such instructions are easily misplaced, and learning a new set of controls for each device may result in formidable complexity.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a device interface system.

FIG. 2 is an action flow diagram of an embodiment of a device interface process.

FIG. 3 is a block diagram of an embodiment of a device interface system comprising a radio tag.

FIG. 4 is an action flow diagram of an embodiment of a interface process to a device comprising a radio tag.

FIG. 5 is a block diagram of an embodiment of a network-connected device interface system.

FIG. 6 is an action flow diagram of an embodiment of a network-connected device interface process.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention. References to “one embodiment” or “an embodiment” do not necessarily refer to the same embodiment, although they may.

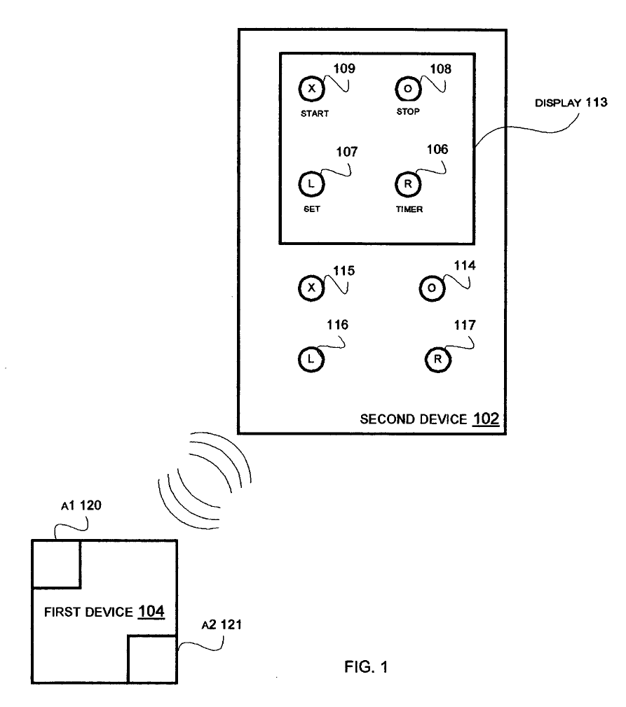

FIG. 1 is a block diagram of an embodiment of a device interface system. The system includes a first device 104 and a second device 102. Examples of a first device 104 include a factory machine, a home appliance, a power tool, a consumer electronics device or a medical device. Examples of a consumer electronics device include a home or car stereo system device, a portable music player, a digital video disk player, a television, or personal hygiene devices such as electronic hair trimmers or electronic toothbrushes. Examples of a second device 102 include a wireless consumer electronics remote control, a cell phone, a camera and/or scanner, a portable music player, or a personal digital assistant (PDA),

The devices 102, 104 communicate wirelessly as a result of the second device 102 being brought into proximity with the first device 104, and/or as a result of an input to the second device 102. Proximity between devices 102, 104 may include short-range wireless communication range, for example Bluetooth™ communication range. Examples of inputs to the second device 102 include operating a control of the second device 102, interacting with a touch screen, or providing a voice command to the device 102.

When proximity occurs between the first 104 and second 102 device, and they communicate either as a result of the proximity or because an input has occurred on the second device 102, the first device 104 may send user-interface information to the second device Configuring the second device 102 in conformity with the user-interface information, such that the second device 102 provides a user-interface to the first device 104, may include mapping functions of the first device 104 to controls of the second device 102. For example, as shown in FIG. 1, controls 114-117 of the second device 102 may be mapped to functions such as “START”, “STOP”, “SET”, “TIMER” which are functions of the first device 104. Configuring the second device 102 in conformity with the user-interface information may include displaying a user interface on a display 113 of the second device 102. Displaying a user interface on the second device 102 may include displaying a correspondence between controls (buttons, dials, levers, etc.) of the second device 102 with functions of the first device 104. For example, representations 106-109 of the buttons 114-117 of the second device 102 may be displayed, along with corresponding functions (e.g. START, STOP, SET, TIMER) of the first device 104 that may be engaged by operating the buttons 114-117.

Presenting a user interface on the second device 102 may include defining touch sensitive areas on a display of the second device 102, and/or associating voice commands or other inputs to the second device with functions of the first device 104. In different embodiments, the second device 102 may have buttons or controls, a touch sensitive area or areas, a display or displays with a graphic user interface or menu and corresponding manners of manipulation, voice input, scanner input, and/or other manners of presenting a user-interface. Controls of the second device may be color coded. For example, the color red could be dynamically assigned to a button with a corresponding “stop” function, green could be dynamically assigned to a button with a corresponding “start” function, and so on.

Controls may activate such that functions such as “start”, “stop”, etc. may be read on or by the control. A graphic, icon, or symbol representing a function may appear on or along side a control, or on the display.

As a result of proximity between the devices 102 and 104, information may be communicated from the first device 104 to the second device 102. The information communicated may include information about one or more of how to operate, repair, maintain, diagnose, or interact with the first device 104. The information may take the form of Hypertext Markup Language (HTML) or Extensible Markup Language (XML).

In some embodiments, different information may be communicated from the first device 104 to the second device 102 according to how the second device 102 is oriented. For example, the first device 104 may include different areas A1 120 and A2 121, and orienting the second device 102 toward area A1 120 may result in the communication of different information than orienting the second device 102 toward A2 121. Orienting toward area A1 120 might result in communication of information relating to problem diagnosis and technical support; whereas pointing to area A2 121 might result in communication of information relating to normal device operation. Orienting toward area A1 120 might result in communication of information relating to using, maintaining, or diagnosing parts of area A1 120; whereas pointing to area A2 121 might result in communication of information relating to using, maintaining, or diagnosing parts of area A2 121.

Communication of different information between device 104 and device 102 may also result from device 102 sending different signals or information to device 104 as they interact. For example, when device 104 and device 102 communicate as a result of an input on device 102, the input may indicate that a maintenance user-interface is to be configured. Device 102 may then send information to device 104 indicating that an operational interface is needed.

Communication of different information from the first device 104 to the second device 102 may also occur according to how the second device 102 is moving. For example, the information communicated may vary according to whether device 102 is approaching or moving away from the device 104, the velocity of motion, or a gesture motion by the second device (e.g. waving the second device, marking an X or circle, horizontal motion, etc.).

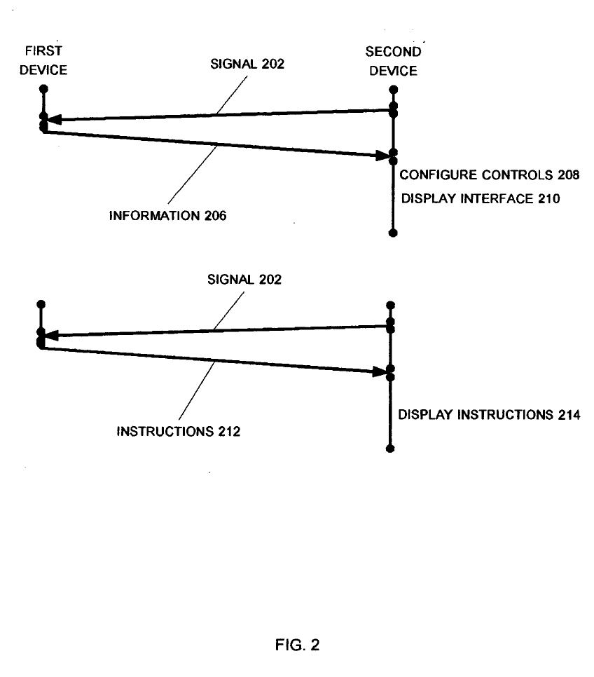

FIG. 2 is an action flow diagram of an embodiment of a device interface process. At 202 the second device provides a signal to the first device. The signal may be initiated automatically as a result of the second device moving in proximity to the first device, or it may be initiated in response to a user action affecting the second device, such as operation of a control. At 206, in response to the signal, the first device provides information to the second device. The provided information may be user interface information for the first device. User-interface information may include information in Hypertext Markup Language or Extensible Markup Language format. The information may be operating instructions, maintenance instructions, or diagnostic instructions for the first device.

The first device may also initiate communication with the second device, and/or provide the information to the second device automatically, when the first and second devices come into proximity. For example, the first device may recognize that it is in a condition where maintenance or repair may be needed, and choose to communicate with the second device upon proximity occurring so that this information may be communicated. The first device may initiate communication due to recognizing the need for updated programming. For example, a prior power outage may have left the first device in a state where it needs setup.

At 208 the second device configures its controls and at 210 displays an interface to the first device.

The first device may also or instead provide information or instructions 212 (such as operating, repair, or maintenance instructions), in which case the second device may display the instructions 214 or indications by which display of the instructions (including audio display e.g. playback) may be initiated.

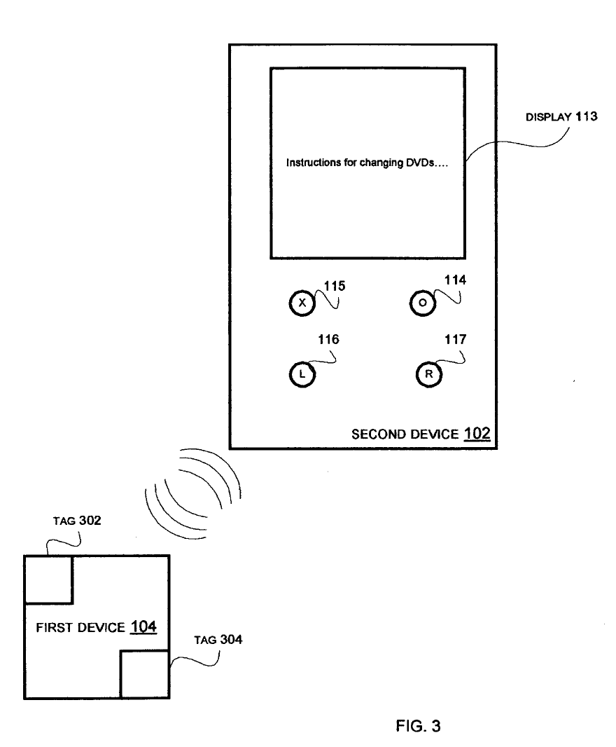

FIG. 3 is a block diagram of an embodiment of a device interface system comprising one or more radio tags. The first device 104 may have one or more radio tags 302, 304 affixed thereto. The second device 102, in the illustrated embodiment, has controls 114-117 and a display 113.

The radio tag(s) 302, 304 may comprise logic to respond to a wireless signal, in this case provided by device 102, by providing instructions or information comprising operating instructions, installation instructions, configuration instructions, assembly instructions, repair instructions, diagnostic instructions, and/or maintenance instructions for a device 104 to which the radio tag is or will be affixed. A radio tag, such as 302, 304 is a small, short-range, low-power or passive device that can respond to wireless signals by activating logic and-or returning stored information. The term “radio frequency” is used herein to describe such devices, as radio frequency is a common frequency range for the technology presently available for such devices. However, radio tags, such as 302, 304, may operate at wireless frequencies other than radio frequencies and are not limited thereto. One or more of the radio tags 302, 304 may comprise logic to respond to a wireless signal by providing at least one of Hypertext Markup Language or Extensible Markup Language information comprising at least one of operating information, repair information, diagnostic information, programming information, and/or maintenance information for a device to which the radio tag is or will be affixed.

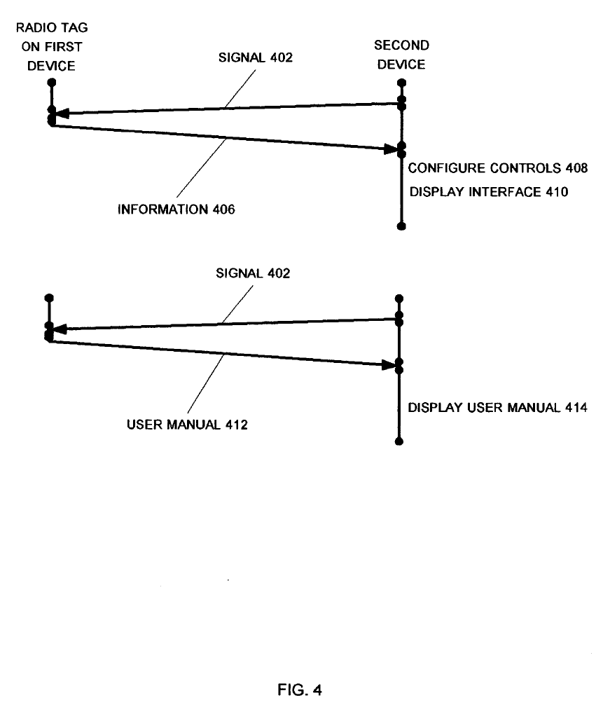

FIG. 4 is an action flow diagram of an embodiment of an interface process to a device comprising one or more radio tags. At 402 the second device provides a signal to a radio tag affixed to a first device. At 406, in response to the signal, the radio tag provides an identification of the first device to the second device. In other embodiments, the radio tag could also initiate communication with the second device, and/or provide the information to the second device automatically, when the first and second devices come into proximity. At 408 the second device configures its controls and at 410 displays an interface to the first device.

The radio tag may also or instead provide instructions 412 (such as operating, repair, diagnostic, programming, and/or maintenance instructions), in which case the second device may display the instructions 414.

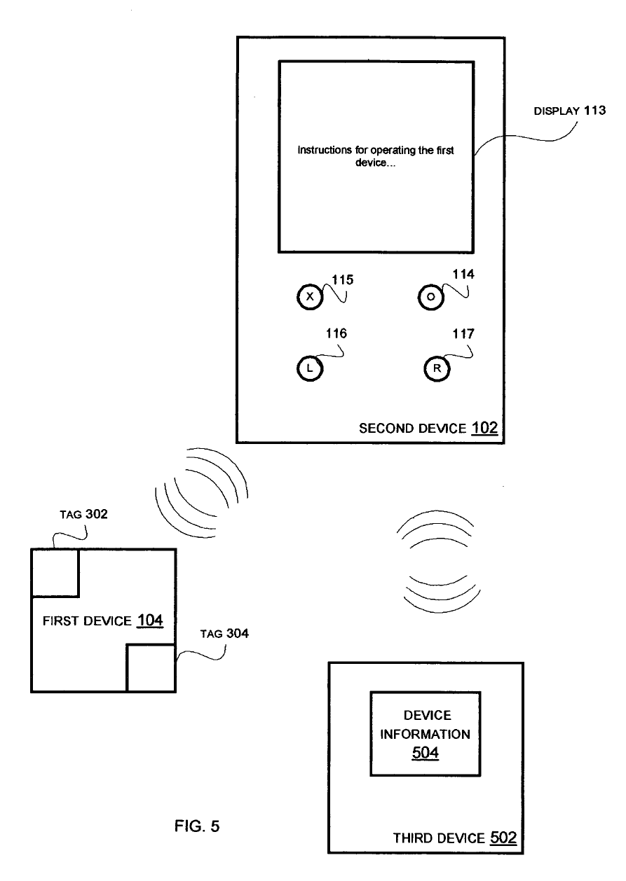

FIG. 5 is a block diagram of an embodiment of a network-connected device interface system. As in FIG. 3, the first device 104 has radio tags 302, 304. The second device 102 has controls 114-117 and a display 113. The system includes a third device 502 comprising device information 504. The third device 502 is in wireless (or wired) communication with the second device 102.

One or more of the radio tags 302, 304 may communicate a device or device part identification (id) to the second device 102. Additionally or alternatively, other information pertaining to the device 104 may be communicated. The id and/or other information communicated may depend upon which of the radio tags 302, 304 to which the second device 102 is pointing. The second device 102 wirelessly (or using wires) communicates the information, such as the id, communicated to it from device 104 (or a part thereof) to a third device 502. The third device 502 may include a device operating at least in part as a network server.

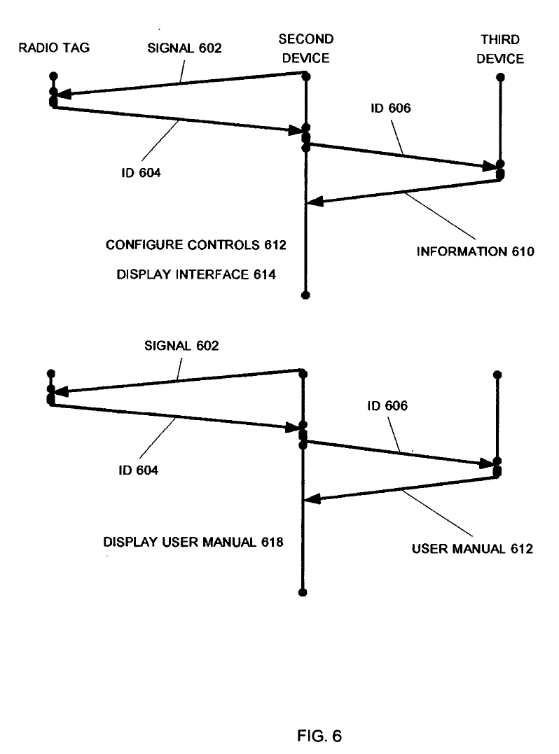

FIG. 6 is an action flow diagram of an embodiment of a network-connected device interface process. At 602 the second device provides a signal to one or more radio tags affixed to a device. At 604 the radio tag or tags provide a device and/or part id to the second device. At 606 the second device provides the device and/or part id to a third device. At 610 the third device provides information about the identified device and/or part to the second device. Examples of information the third device might provide to the second device about the first device comprise information for establishing a user interface to the first device and/or part thereof, or instructions for operating, maintaining, repairing, or troubleshooting the first device.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

What is claimed is:

1. A method comprising:
wirelessly communicating user-interface information from a first device to a second device as a result of the second device being brought into proximity with the first device; and
configuring the second device in conformance with the user-interface information such that the second device provides a user-interface to the first device.

2. The method of claim 1, wherein the configuring the second device in conformance with the user-interface information such that the second device provides a user-interface to the first device further comprises:
mapping functions of the first device to controls of the second device.

3. The method of claim 2, wherein the first device further comprises:
at least one of a factory machine, a home appliance, or a power tool.

4. The method of claim 2, wherein the first device further comprises:
a consumer electronics device.

5. The method of claim 4, wherein the consumer electronics device further comprises:
a home or car stereo system device, a portable music player, a digital video disk player, or a television.

6. The method of claim 2, wherein the second device further comprises:
a wireless consumer electronics remote control.

7. The method of claim 2, wherein the second device further comprises:
a device comprising at least one of a cell phone, a camera, or a portable music player.

8. The method of claim 2, wherein the first device further comprises:
a medical device.

9. The method of claim 1, wherein the configuring the second device in conformance with the user-interface information such that the second device provides a user-interface to the first device further comprises:
displaying, according to the user-interface information, a user interface on the second device.

10. The method of claim 9, wherein the displaying, according to the user-interface information, a user interface on the second device further comprises:
displaying a user interface showing a correspondence between at least one of buttons, dials, or levers of the second device with functions of the first device.

11. The method of claim 9, wherein the displaying, according to the user-interface information, a user interface on the second device further comprises:
marking off touch sensitive areas on a display of the second device.

12. The method of claim 9, wherein the user-interface information further comprises:
Hypertext Markup Language information.

13. The method of claim 1, wherein the proximity with the first device further comprises:
short-range wireless communication range.

14. The method of claim 13, wherein the short-range wireless communication range further comprises:
Bluetooth communication range.

15. The method of claim 1, wherein the user-interface information further comprises:
Hypertext Markup Language information.

16. The method of claim 1, wherein the first device further comprises:
at least one of a factory machine, a home appliance, or a power tool.

17. The method of claim 1, wherein the first device further comprises:
a consumer electronics device.

18. The method of claim 17, wherein the consumer electronics device further comprises:
a home or car stereo system device, a portable music player, a digital video disk player, or a television.

19. The method of claim 1, wherein the second device further comprises:
a wireless consumer electronics remote control.

20. The method of claim 1, wherein the second device further comprises:
a device comprising at least one of a cell phone, a camera, or a portable music player.

21. The method of claim 1, wherein the first device further comprises:
a medical device.

22. A method comprising:
wirelessly communicating user-interface information from a first device to a second device automatically in response to coming into proximity with the first device, or in response to operating a control of the second device; and
configuring the second device in conformance with the user-interface information such that the second device provides a user-interface to the first device.

23. The method of claim 22, wherein the configuring the second device in conformance with the user-interface information such that the second device provides a user-interface to the first device further comprises:
mapping functions of the first device to controls of the second device.

24. The method of claim 23, wherein the first device further comprises:
at least one of a factory machine, a home appliance, or a power tool.

25. The method of claim 23, wherein the first device further comprises:
a consumer electronics device.

26. The method of claim 25, wherein the consumer electronics device further comprises:
a home or car stereo system device, a portable music player, a digital video disk player, or a television.

27. The method of claim 23, wherein the second device further comprises:
a wireless consumer electronics remote control.

28. The method of claim 23, wherein the second device further comprises:
a device comprising at least one of a cell phone, a camera, or a portable music player.

29. The method of claim 23, wherein the first device further comprises:
a medical device.

30. The method of claim 22, wherein the configuring the second device in conformance with the user-interface information such that the second device provides a user-interface to the first device further comprises:
displaying, according to the user-interface information, a user interface on the second device.

31. The method of claim 30, wherein the displaying, according to the user-interface information, a user interface on the second device further comprises:
displaying a user interface showing a correspondence between at least one of buttons, dials, or levers of the second device with functions of the first device.

32. The method of claim 30, wherein the displaying, according to the user-interface information, a user interface on the second device further comprises:
marking off touch sensitive areas on a display of the second device.

33. The method of claim 30, wherein the user-interface information further comprises:
Hypertext Markup Language information.

34. The method of claim 22, wherein the proximity with the first device further comprises:
short-range wireless communication range.

35. The method of claim 34, wherein the short-range wireless communication range further comprises:
Bluetooth communication range.

36. The method of claim 22, wherein the user-interface information further comprises:
Hypertext Markup Language information.

37. The method of claim 22, wherein the first device further comprises:
at least one of a factory machine, a home appliance, or a power tool.

38. The method of claim 22, wherein the first device further comprises:
a consumer electronics device.

39. The method of claim 38, wherein the consumer electronics device further comprises:
a home or car stereo system device, a portable music player, a digital video disk player, or a television.

40. The method of claim 22, wherein the second device further comprises:
a wireless consumer electronics remote control.

41. The method of claim 22, wherein the second device further comprises:
a device comprising at least one of a cell phone, a camera, or a portable music player.

42. The method of claim 22, wherein the first device further comprises:
a medical device.

43. A method comprising:
establishing a wireless communication connection between a first device and a second device in response to one of bringing the second device into proximity with the first device or operating a control of the second device; and
wirelessly communicating user-interface information from a first device to a second device automatically in response to coming into proximity with the first device, and/or in response to operating a control of the second device.

44. The method of claim 43, wherein the proximity with the first device further comprises:
short-range wireless communication range.

45. The method of claim 44, wherein the short-range wireless communication range further comprises:
Bluetooth communication range.

46. The method of claim 43, wherein the user-interface information further comprises:
Hypertext Markup Language information.

47. The method of claim 43, wherein the first device further comprises:
at least one of a factory machine, a home appliance, or a power tool.

48. The method of claim 43, wherein the first device further comprises:
a consumer electronics device.

49. The method of claim 48, wherein the consumer electronics device further comprises:
a home or car stereo system device, a portable music player, a digital video disk player, or a television.

50. The method of claim 43, wherein the second device further comprises:
a wireless consumer electronics remote control.

51. The method of claim 43, wherein the second device further comprises:
a device comprising at least one of a cell phone, a camera, or a portable music player.

52. The method of claim 43, wherein the first device further comprises:
a medical device.

53. A method comprising:
wirelessly communicating operating instructions for a first device from the first device to a second device automatically in response to coming into proximity with the first device, or in response to operating a control of the second device.

54. The method of claim 53, wherein the proximity with the first device further comprises:
short-range wireless communication range.

55. The method of claim 54, wherein the short-range wireless communication range further comprises:
Bluetooth communication range.

56. The method of claim 53, wherein the first device further comprises:
at least one of a factory machine, a home appliance, or a power tool.

57. The method of claim 53, wherein the first device further comprises:
a consumer electronics device.

58. The method of claim 57, wherein the consumer electronics device further comprises:
a home or car stereo system device, a portable music player, a digital video disk player, or a television.

59. The method of claim 53, wherein the second device further comprises:
a wireless consumer electronics remote control.

60. The method of claim 53, wherein the second device further comprises:
a device comprising at least one of a cell phone, a camera, or a portable music player.

61. The method of claim 53, wherein the first device further comprises:
a medical device.

62. A method comprising:
wirelessly communicating at least one of maintenance or repair instructions for a first device from the first device to a second device in response to operating a control of the second device or automatically in response to coming into proximity with the first device.

63. The method of claim 62, wherein the proximity with the first device further comprises:
short-range wireless communication range.

64. The method of claim 63, wherein the short-range wireless communication range further comprises:
Bluetooth communication range.

65. The method of claim 62, wherein the first device further comprises:
at least one of a factory machine, a home appliance, or a power tool.

66. The method of claim 62, wherein the first device further comprises:
a consumer electronics device.

67. The method of claim 66, wherein the consumer electronics device further comprises:
a home or car stereo system device, a portable music player, a digital video disk player, or a television.

68. The method of claim 62, wherein the second device further comprises:
a wireless consumer electronics remote control.

69. The method of claim 62, wherein the second device further comprises:
a device comprising at least one of a cell phone, a camera, or a portable music player.

70. The method of claim 62, wherein the first device further comprises:
a medical device.

71. A radio tag comprising:
logic to respond to a wireless signal by providing at least one of operating instructions, installation instructions, configuration instructions, assembly instructions, repair instructions, diagnostic instructions, or maintenance instructions for a device to which the radio tag is or will be affixed.

72. A radio tag comprising:
logic to respond to a wireless signal by providing at least one of Hypertext Markup Language or Extensible Markup Language information comprising at least one of a operating information, repair information, or maintenance information for a device to which the radio tag is or will be affixed.

73. The radio tag of claim 72, further comprising:
logic to provide different information according to differences in the wireless signal received.

74. The radio tag of claim 72, wherein the Hypertext Markup Language or Extensible Markup Language information further comprises:
information about one or more of how to operate, repair, maintain, diagnose, or interact with a part of the device to which the radio tag is or will be affixed.

75. The radio tag of claim 72, wherein the operating instructions, installation instructions, configuration instructions, assembly instructions, repair instructions, diagnostic instructions, or maintenance instructions for a device further comprises:
operating instructions, installation instructions, configuration instructions, assembly instructions, repair instructions, diagnostic instructions, or maintenance instructions for a factory machine, a home appliance, or a power tool.

76. The radio tag of claim 72, wherein the operating instructions, installation instructions, configuration instructions, assembly instructions, repair instructions, diagnostic instructions, or maintenance instructions for a device further comprises:
operating instructions, installation instructions, configuration instructions, assembly instructions, repair instructions, diagnostic instructions, or maintenance instructions for a consumer electronics device.

77. The radio tag of claim 76, wherein the operating instructions, installation instructions, configuration instructions, assembly instructions, repair instructions, diagnostic instructions, or maintenance instructions for a consumer electronics device further comprises:
operating instructions, installation instructions, configuration instructions, assembly instructions, repair instructions, diagnostic instructions, or maintenance instructions for a home or car stereo system device, a portable music player, a digital video disk player, or a television.

78. The radio tag of claim 72, wherein information comprising at least one of a operating information, repair information, or maintenance information further comprises:
information comprising at least one of a operating information, repair information, or maintenance information for a medical device.

79. The radio tag of claim 73, wherein the first device further comprises:
at least one of a factory machine, a home appliance, or a power tool.

79. A method comprising:
a second device identifying a first proximate device via wireless signals;
the second device wirelessly communicating an identification of the first device to a third device; and
the second device receiving from the third device user-interface information for the first device.

80. The method of claim 79, wherein the user-interface information further comprises:
at least one of Extensible Markup Language and Hypertext Markup Language information.

81. The method of claim 79, wherein the first device further comprises:
at least one of a factory machine, a home appliance, or a power tool.

82. The method of claim 79, wherein the first device further comprises:
a consumer electronics device.

83. The method of claim 82, wherein the consumer electronics device further comprises:
a home or car stereo system device, a portable music player, a digital video disk player, or a television.

84. The method of claim 79, wherein the second device further comprises:
a wireless consumer electronics remote control.

85. The method of claim 79, wherein the second device further comprises:
a device comprising at least one of a cell phone, a camera, or a portable music player.

86. The method of claim 79, wherein the third device further comprises:
a device operating at least in part as a network server.

87. The method of claim 79, wherein the identifying a first proximate device further comprises:
receiving identifying signals from a radio tag affixed to the first device.

88. The method of claim 79, wherein the first device further comprises:
a medical device.
